(19) United States
(12) Patent Application Publication
(10) Pub. No.: US 2013/0240135 A1
(43) Pub. Date: Sep. 19, 2013

(54) ARRANGEMENT AND ITS USE FOR APPLYING DECORATIVE RIGID BODIES TO A SUBSTRATE, AND ITS METHOD OF MANUFACTURE

(71) Applicant: Roland F. GRATZER, Wien (AT)

(72) Inventor: Roland F. GRATZER, Wien (AT)

(73) Assignee: GRATZER! TECHNOLOGIES GMBH & CO. KG, Wien (AT)

(21) Appl. No.: 13/787,104

(22) Filed: Mar. 6, 2013

(30) Foreign Application Priority Data
Mar. 8, 2012 (EP) 12001604.3
Jul. 10, 2012 (EP) 12005093.5

(51) Int. Cl. B44C 3/12; B44F 11/04

(52) U.S. Cl. CPC B44C 3/12; B44F 11/04
USPC 156/249; 156/252; 428/67

(57) ABSTRACT

A decorative rigid body supply arrangement comprises a supply strip which includes a plurality of through holes extending from the upper side to the lower side and spaced apart in the direction of elongation; a plurality of decorative rigid bodies received in the through holes, wherein each through hole has an inner periphery which is in contact with an upper portion of an outer periphery of the decorative rigid body received in the through hole; and one or more elastic tapes adhered to the lower side of the supply strip, wherein the one or more elastic tapes provide at least one aperture, wherein the at least one aperture is registered with at least one of the through holes, wherein a periphery of the one or more elastic tapes holds the decorative rigid body within the through hole.

### TECHNICAL FIELD

The present invention relates to arrangements and their use for applying decorative rigid bodies to a substrate.

### BACKGROUND OF THE INVENTION

European patent application EP 1 013 476 A1 discloses a method for applying decorative rigid bodies to a substrate, wherein the bodies are adhered with their front faces to an intermediate transfer substrate in a desired pattern. The back faces of the decorative rigid bodies are provided with an adhesive, and a target substrate is bought into contact with the adhesive on the back faces of the rigid bodies. The adhesive is activated and the intermediate substrate is removed such that the decorative rigid bodies adhered to the target substrate in the desired pattern.

### SUMMARY OF THE INVENTION

It is judicious to position and adhere the decorative rigid bodies to a substrate in a desired pattern.

It is an object of the present invention to provide a supply arrangement for decorative rigid bodies and a corresponding method which facilitates positioning and adhering of decorative rigid bodies to a substrate.

According to some embodiments, a decorative rigid body supply arrangement comprises: A supply strip having a direction of elongation, left and right sides and upper and lower sides, wherein the supply strip includes a plurality of through holes extending from the upper side to the lower side and spaced apart in the direction of elongation; and a plurality of decorative rigid bodies received in the through holes; and at least one elastic tape adhered to the lower side of the supply strip, wherein the elastic tape provides at least one aperture, wherein the at least one aperture is registered with at least one of the through holes; wherein each through hole has an inner periphery which is in contact with an upper portion of an outer periphery of the decorative rigid body received in the through hole; wherein a periphery of the at least one elastic tape is in contact with a lower portion of the decorative rigid body received in the through hole.

Within the context of the present application, a decorative rigid body can be any solid body which can be adhered to a substrate. Examples of such rigid bodies are crystals and pieces of glass. The rigid bodies may have diameters in the order of millimetres, such as 1 millimetre to 5 millimetres. The rigid bodies may have a polyhedral shape having many facets such that light incident on the body is reflected and deflected in many directions. Further, the adhering may in each case be accomplished by a separate adhesive, or by one or both adhering components being made adhesive by heating or partial melting, as the case may be.

The supply strip has a function as a carrier for supplying the rigid bodies to an apparatus which applies the rigid bodies to a substrate at desired locations. For this purpose, the apparatus may have a configuration similar to a matrix printer having a printing head which can be moved in two orthogonal directions relative to the substrate. The supply strip carrying the rigid bodies supplies the rigid bodies to the printer head, and the printer head includes a mechanism, such as a piston, which pushes the rigid bodies out of the through holes such that they adhere to the substrate at desired locations.

The supply strip can be made of plastics, such as PET. The supply strip can be flexible, such that the supply strip carrying the rigid body can be stored as a coil in a cartridge of the printer head. On the other hand, the supply strip has a sufficient rigidity, such that a transport mechanism of the printer head can reliably move the supply strip in the direction of its elongation relative to the mechanism, such as the piston, in order to bring subsequent rigid bodies in alignment with the piston.

Moreover, it is desired that the rigid bodies are reliably maintained in their position within the through holes of the supply strip, such that they do not inadvertently fall out of the through holes if the supply strip is manipulated. On the other hand, it is desirable that the rigid bodies can be pushed out of the through holes by applying small forces via the mechanism, such as a piston, designed for adhering the rigid bodies to the substrate.

The inventor has found that the rigid bodies are reliably maintained in position within the through holes and can still be pushed out of the through hole by a relatively small force, if the elastic tape adhering to the lower side of the supply strip performs a function of holding the rigid body in its through hole. The elastic tape can be deformed by applying a relatively small force to the rigid body such that the deformed elastic tape either permits a piston or the like to enter the through hole and push out the rigid body to the opposing side; or else, the elastic tape deforms such that the rigid body can be pushed out of the through hole on the side of the elastic tape. The elastic tape need not have a contiguous structure covering the through hole and the rigid body contained therein. The elastic tape provides an aperture which is registered with the through hole and in one embodiment allows the rigid body to penetrate therethrough when the elastic tape is deformed, while a periphery of the elastic tape performs a function of holding the rigid body within the through hole when the elastic tape is not yet deformed.

According to some embodiments, the inner periphery of the through holes is configured and arranged to prevent the decorative rigid body from falling out of the through hole at the upper side of the supply strip. According to other exemplary embodiments, the periphery of the at least one elastic tape is configured and arranged to prevent the decorative rigid body from falling out of the through hole at the lower side of the supply strip.

According to some exemplary embodiments, the supply strip has a smallest thickness in a region between adjacent through holes. The smallest thickness is measured in a direction orthogonal to the lower side of the supply strip. Locations where the elastic tape contacts the lower portion of the outer periphery of the decorative rigid body and where the inner periphery of the through hole contacts the upper portion of the outer periphery of the decorative rigid body are spaced apart from each other by a distance measured in the same direction orthogonal to the lower side of the supply strip. In this configuration, the distance is greater than the smallest thickness. The smallest thickness can be selected such that it provides sufficient rigidity to the supply strip such that it can be reliably manipulated, wherein the smallest thickness can be selected sufficiently low such that it allows bending of the supply strip in order to store a long supply strip as a coil in a cartridge.

According to further embodiments, the elastic tape has a thickness, measured in the same direction orthogonal to the lower side of the supply strip, which is at least 2 times, at least 4 times, or at least 8 times smaller than the smallest thickness of the supply strip.

According to other embodiments, the thickness of the elastic tape is less than 0.1 mm or less than 0.6 mm, in order to provide sufficient elasticity such that a relatively small force can push the rigid body out of the through hole.

According to some embodiments, the supply strip and/or the elastic tape are made of plastics, such as PET.

According to some embodiments, the elastic tape comprises first and second separate elastic tapes adhered to the lower side of the supply strip, wherein the first and second elastic tapes are spaced apart from each other in order to define the at least one aperture, wherein the at least one aperture is a contiguous aperture extending across plural adjacent through holes or even all through holes. This allows for an easy manufacture of the supply arrangement since it is not always necessary to exactly position the elastic tape in the longitudinal direction of the supply strip which would be otherwise necessary if individual separated apertures were provided in the elastic tape which would have to be registered relative to the through holes in the longitudinal direction of the supply strip.

According to exemplary embodiments, the decorative rigid bodies have a greatest diameter in a region between the locations where the elastic tape and the inner periphery of the through hole contact the lower and upper portions, respectively, of the outer periphery of the decorative rigid bodies. This may ensure that the rigid bodies do not inadvertently fall out of the through holes.

According to certain embodiments, the lower portion of the outer periphery of the decorative rigid body has a surface normal at a location where the elastic tape contacts the lower portion of the outer periphery of the decorative rigid body, and an orientation of the surface normal is selected such that an angle between the surface normal and a plane of extension of the lower side of the supply strip is smaller than 75°, smaller than 65°, or smaller than 50°. Such arrangement allows the rigid body to penetrate the aperture of the elastic tape by applying a relatively small force.

According to another aspect, the present invention provides a method of applying decorative rigid bodies to a substrate, wherein the method comprises: supplying the decorative rigid bodies using a supply arrangement, such that at least one decorative rigid body is arranged close to a first substrate; and pushing the at least one decorative rigid body out of a through hole provided in the supply arrangement, such that the decorative rigid body contacts the first substrate.

According to some embodiments, the first substrate is the target substrate to which the decorative rigid bodies are to be applied. In this case, the larger of the two end faces of the rigid bodies may be the leading faces in the movement towards the first (target) substrate.

According to other embodiments, the first substrate is an intermediate transfer substrate which is used to apply the rigid bodies adhered to the first substrate to a second substrate which may form the target substrate. In this case, the smaller of the two end faces of the rigid bodies may be the leading faces in the movement towards the first (intermediate transfer) substrate.

According to exemplary embodiments, the supply arrangement used in the method is one of the decorative rigid body supply arrangements illustrated above.

According to some embodiments, the decorative rigid bodies are supplied such that the lower side of the supply strip is oriented towards the first substrate such that the rigid bodies can be pushed through the aperture of the elastic tape in order to achieve contact with the first substrate.

According to alternative embodiments, the decorative rigid bodies are supplied such that the upper side of the supply strip is oriented towards the first substrate such that the rigid bodies can be pushed through the bottoms of the through holes in order to contact the first substrate.

According to some embodiments, the method comprises activating a first adhesive provided between the decorative rigid body and the first substrate such that the decorative rigid body adheres to the first substrate. The first adhesive can be provided on the rigid body or on the first substrate. According to exemplary embodiments herein, the first adhesive is activated by applying pressure between the rigid body and the first substrate.

According to certain exemplary embodiments, the method comprises bringing plural decorative rigid bodies adhered to the first substrate in contact with a second substrate, activating a second adhesive provided between the rigid bodies and the second substrate; and separating the first substrate from the plural decorative rigid bodies. The second substrate can be the target substrate. The second adhesive can be provided on the rigid bodies or on the second substrate. According to exemplary embodiments, the second adhesive is activated by applying heat to the second adhesive.

According to an aspect of the invention, the decorative rigid body supply arrangement is manufactured by providing bottomed pouches in a flat strip material; punching holes in the pouch bottoms so as to provide the through holes; optionally cutting slits, e.g. one or two pairs of slits, in the pouch rims from their bottom sides, further optionally orienting the slits in the direction of elongation; placing the decorative rigid bodies in the pouches, optionally leaving leading pouches empty; adhering the one or more elastic tapes onto the side of the strip material away from the bottoms, optionally by welding; and providing the plurality of projections and indentations on the left and/or right side of the supply strip. Naturally, instead of punching holes in the pouch bottoms, the holes may also be punched first, and the pouches provided later on at the same strip positions. Similarly, the slits can be provided before actually providing the pouches, if desired.

### BRIEF DESCRIPTION OF THE DRAWINGS

The foregoing as well as other advantageous features of the present disclosure will be more apparent from the following detailed description of exemplary embodiments with reference to the accompanying drawings. Not all possible embodiments of the present invention necessarily exhibit each and every, or any, of the advantages identified.

FIG. 1 is a side view of a supply arrangement;

FIG. 2 is an elevational view of a lower side of the supply arrangement shown in FIG. 1;

FIG. 3 is a cross section of the supply arrangement shown in FIG. 1 along a line III-III shown in FIG. 1;

FIG. 4 is an elevational view on a lower side of a supply strip;

FIG. 5 is a cross section of the supply strip shown in FIG. 4 along a line V-V shown in FIG. 4;

FIG. 6 is a side view of another supply arrangement;

FIG. 7 is a cross sectional view of the embodiment of FIG. 6; and

FIG. 8 is a perspective view of the same embodiment from the lower side thereof;

FIG. 9 illustrates a decorative rigid body supply apparatus and method for applying decorative rigid bodies; and

FIG. 10 is a further illustration of a method of applying decorative rigid bodies.

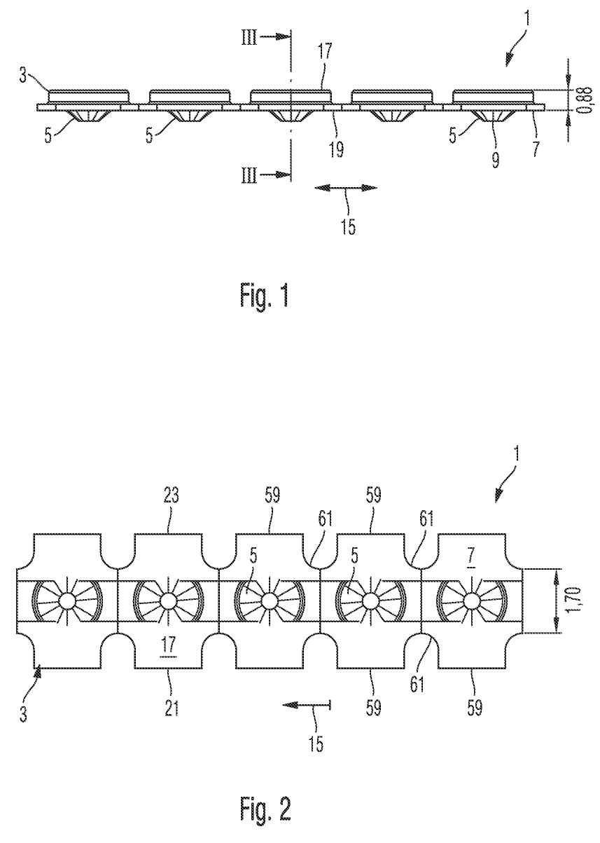

A first embodiment of a decorative rigid body supply arrangement is illustrated with reference to FIGS. 1 to 3 below.

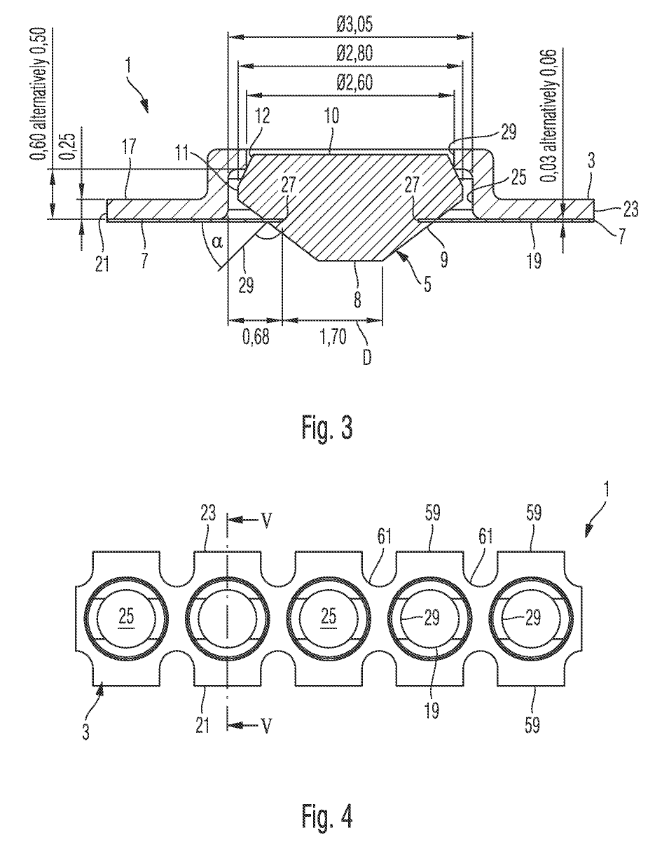

This exemplary decorative rigid body supply arrangement 1 comprises a supply strip 3, decorative rigid bodies 5 and elastic tapes 7. The decorative rigid bodies may be crystals or pieces of glass or other rigid bodies. In the illustrated embodiment, the rigid bodies are made of glass and have a multi-faceted surface in order to deflect incident light into many directions. As can be seen in the cross section of FIG. 3, a rigid body has a lower face 8, an upper face 10 and a central periphery 11 having a maximum diameter. An upper portion 12 of the outer periphery of the rigid body is frustopyramidal such that the diameter of the rigid body 5 tapers towards the upper face 10. Similarly, a lower portion 13 of the outer periphery of the rigid body 5 is frustopyramidal and tapers towards the lower face 8, but with a different tapering angle. In other words, the rigid bodies are bi-frustopyramidal inasmuch as their diameter is largest at some intermediate thickness, usually offset from the center, and both the upper and the lower portion are each frustopyramidal, but with different heights. In this context, the “diameter” of the frustopyramid is taken as the longest diagonal of the polygonal cross section at a given distance from the end face.

In some embodiments, upper face 10 can be flat and can project upwardly relative to upper side 17 by more than 0.01 mm and/or by less than 0.10 mm. In some embodiments, face 8 may be flat and may project downwardly from lower side 19 by more than 0.01 mm, by less than 0.10 mm, by more than 0.10 mm and/or by less than 1.00 mm.

The elongated supply strip 3 has a direction of elongation in a longitudinal direction represented by an arrow 15. The supply strip 3 has an upper side 17, a lower side 19, a left side 21 and a right side 23.

The supply strip 3 includes a plurality of through holes 25 which are spaced apart in the longitudinal direction 15. Each through hole 25 accommodates one rigid body 5. The through hole 25 has an inner periphery 29 which contacts the upper portion 12 of the outer periphery of the rigid body 5 such that the rigid body 5 is prevented from falling out of the through hole 25 at the upper side 17 of the supply strip 3.

Two straight elastic tapes 7 are applied to the lower side 19 of the supply strip 3 such that inner edges 27 of the elastic tapes 7 are separated by a distance D from each other, if the rigid body 5 was not present within the through hole 25. However, the tapes 7 are elastic and will deform when they are applied to the lower side 19 of the supply strip 3 when the rigid body 5 is present in the through hole 25 such that the inner periphery 27 is in contact with the lower portion 9 of the outer periphery of the rigid body, and such that a restoring elastic force of the elastic tapes 3 maintains the rigid body 5 within the through hole 25 and prevents the decorative rigid body 5 from falling out of the through hole 25 at the lower side 19 of the supply strip 3.

The lower portion 9 of the outer periphery of the decorative rigid body has a surface normal 29 at a location where the elastic tape 7 contacts the outer periphery. An angle α between the surface normal 29 and the plane of extension of the lower side 19 or the plane of extension of the elastic tape 7 is ˜45° in the illustrated embodiment.

The decorative rigid body 5 can be pushed out of the through hole 25 by applying a force to the upper face 10 of the rigid body 5. The force is oriented in the downward direction of FIG. 3 and pushes the rigid body 5 downwards, wherein the lower portion 9 of the outer periphery penetrates the aperture defined by the edges 27 of the elastic tapes 7. During this process, the elasticity of the elastic tape allows the tape to deform more and more such that the rigid body can completely penetrate the aperture in order to get pushed out of the through hole 25.

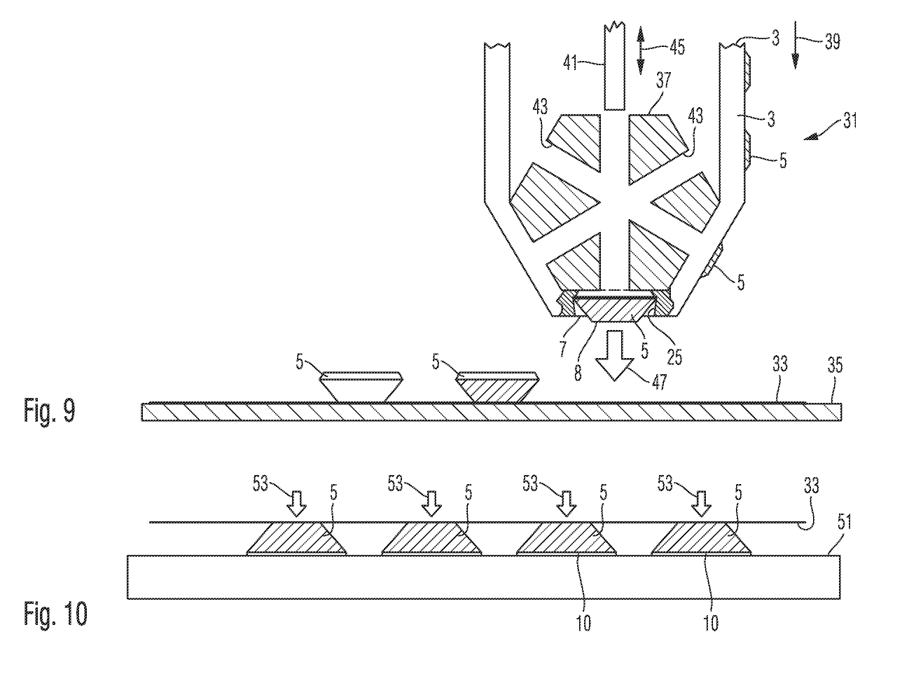

This process can be used to attach the rigid body 5 with its lower face 8 to a desired substrate as will be illustrated with reference to FIGS. 9 and 10 below:

FIG. 9 shows a mechanism 31 for applying rigid bodies 5 to a substrate 33. The substrate can be a target substrate, wherein it is intended to apply the rigid bodies to this target substrate such that they are durably adhered thereto. The target substrate can be a paper, a cardboard or a textile material, leather or even human skin.

In the illustrated embodiment, the substrate 33 is an intermediate transfer foil supported on a table 35.

The mechanism 31 includes a (in this example: hexagonal) transport wheel 37 to which the supply strip 3 loaded with rigid bodies 5 is supplied in a transport direction indicated by an arrow 39. The hexagonal transport wheel 37 has three through holes 43 extending in a radial direction of the transport wheel 37 such that a piston 41 can be moved in a direction indicated by an arrow 45 in order to push the rigid body 5 out of the through hole 25 of the supply strip 3 in a direction indicated by an arrow 47 in FIG. 9. However, other types of transport structures are likewise contemplated. In particular, the function of the wheel may be accomplished by two spaced apart disks between which the piston moves.

The substrate 33 is positioned relative to the mechanism 31 such that the piston 41 can bring the lower face 8 of the rigid body 5 into contact with the substrate 33 when the rigid body 5 is pushed out of the through hole 27. The substrate 33 carries an adhesive which is activated by the pressure of the piston 41 such that the lower face 8 of the rigid body adheres to the substrate.

Thereafter, the piston 41 is withdrawn and the hexagonal transport wheel 37 is rotated by 60° such that a next rigid body 5 is positioned opposite to the substrate and can be brought into contact with the substrate by the operation of the piston 41.

The mechanism 31 can be displaced relative to the substrate such that each subsequent rigid body can be applied to a desired location on the substrate. With such process it is possible to apply the rigid bodies to the substrate according to a desired pattern.

Thereafter, the intermediate transfer foil 33 is removed from the table 35 in order to apply the rigid bodies 5 adhere to the intermediate transfer foil 33 to a target substrate 51 as shown in FIG. 10. Forces illustrated by arrows 53 are applied to the rigid bodies 5 via the intermediate transfer foil 33 in order to attach the rigid bodies with their upper face 10 to the target substrate 51. For this purpose, an adhesive can be provided between the upper faces 10 and the target substrate 51. In the illustrated example, the upper faces 10 of the rigid bodies 5 carry a hot melt adhesive which is activated by applying heat to the substrate in order to adhere the rigid bodies to the target substrate 51.

Incidentally, FIG. 2 shows that the left and right sides 21, 23 of the supply strip 3 have a plurality of projections 59 and indentations 61 which are provided for engagement with pins or bosses of a transport mechanism, such as a tractor included in the mechanism 31 to move the supply strip 3 in the direction 39.

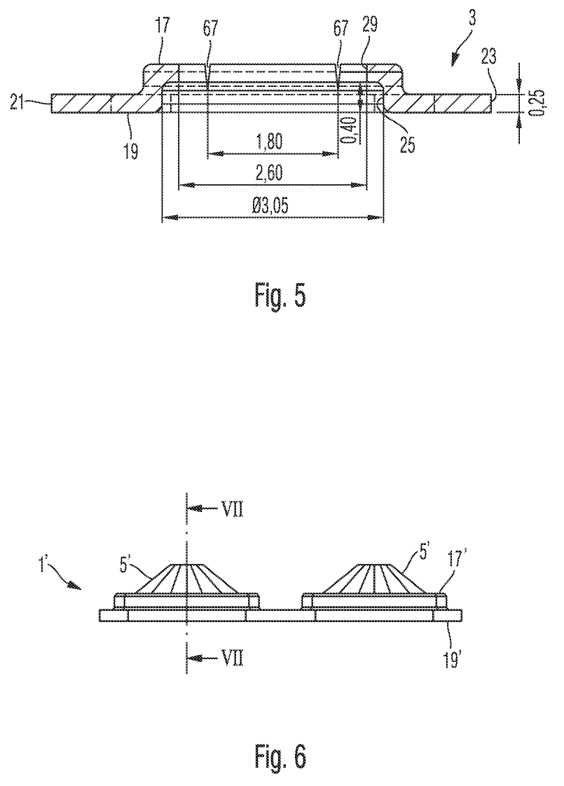

FIGS. 4 and 5 illustrate a further embodiment of a supply strip 3. This embodiment of the supply strip 3 differs from the embodiment shown in FIGS. 1 to 3 mainly in that the inner periphery 29 of the through hole 25 is separated by slits 67 rather than being a contiguous inner periphery. The slits 67 provide an increased elasticity to the structured shape of the supply strip 3 such that it provide a lower resistance against being deformed and manipulated while still securing the rigid bodies within the through holes. E.g., the slits 67 enable the rigid bodies to be pushed out of the through holes 25 towards the upper sides. This may be accomplished by supplying the supply strip to the piston with the lower side up, i.e. the elastic tape or tapes facing the piston. In this manner, the piston can enter between the deforming elastic tapes and exert a force onto the rigid body to be transferred, thereby forcing same out of the through hole on the side away from the elastic tape. In this embodiment, two or four slits may be useful.

Furthermore, the slits may have the same direction, either all of them or pairs of them. In this case, manufacture of the slits is easier. This is particularly so if the slit direction is parallel to the longitudinal extension. Such slits are also contemplated in the embodiment of FIGS. 1 to 3, although not specifically shown, if contemplated for forcing the rigid bodies out of the through holes from the upper side.

Generally, the supply arrangement can be manufactured by first providing recesses in a flat PET or PP material as pouches, punching the through holes in the pouch bottoms, providing the slits in the pouch rims, placing the rigid bodies into the pouches, leaving the first pouches empty for later use as an aid to introduce the strip into an application device, then welding the spaced-apart elastic tapes onto the pouches so as to encage the decorative rigid bodies in the pouches, and only then to provide the tractor features in the side rim or rims. If these protrusions and indentation are provided before welding the elastic tapes, same need to be provided with notches as well which have to be in lengthwise registration with those of the supply strip, adding to the complexity of the method. Naturally, the one or more aperture formed in or by the elastic tape(s) need to be in registration with the pouches in the widthwise direction of the supply arrangement.

In this embodiment, the elastic tape or tapes 7 serve to let the piston enter into the through hole for expelling the decorative rigid bodies 5 mechanically. In order for the piston not to face excessive resistance, it has been found that the aperture provided by the elastic tape or tapes may be oblong, i.e. have an aspect ratio of larger than 2. Good results are obtained if the length of each aperture is at least twice the pitch, covering plural through holes. The aperture width D being less than the diameter of the covered through holes, depending on the ratio of this diameter to the pitch (which is necessarily less than 1 but usually larger than 0.5), in embodiments the aspect ratio is between 4 and infinity (meaning there are two elastic tapes forming a gap between them; in this latter case, the ratio of the strip length to the gap width is the upper limit for the aspect ratio.)

FIGS. 1, 2, 3 and 5 show dimensions in millimetres. These dimensions are exemplary dimensions of the illustrated embodiments and are not limiting the invention in any way. All the given dimensions may be altered in proportion or individually by ±20% or ±60% of their indicated value.

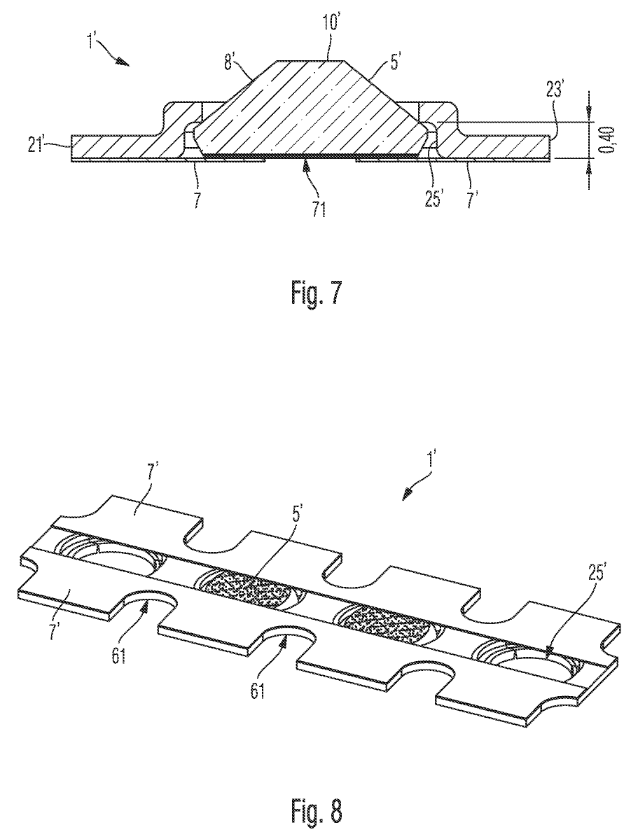

FIG. 6 illustrates how the rigid bodies are accommodated in a supply arrangement 1′ similar to FIGS. 4 and 5. It will be noted that in this alternative embodiment, the bodies 5′ protrude from the upper side 17′ of the supply arrangement 1′, although in a variant not shown, this need not be the case. The dashed line VII-VII indicates the position of the cross section shown in FIG. 7. In this embodiment, the hot melt adhesive 71 is applied on the lower sides 8′, which in this case are larger than the upper faces 10′. This arrangement is inverted with respect to the one shown in FIGS. 1 to 3, where the lower faces 8 are smaller than the upper faces 10. In other words both embodiments include protruding smaller end faces of bi-frustopyramidal bodies. As in the former embodiment, again the supply arrangement 1′ has left 21′, right 23′ and lower sides 19′, elastic tapes 7′ and through holes 25′. FIG. 8 shows the strip from below, with the staggered arrangement of the notches 61 with respect to the through holes 25′.

The skilled person will readily become aware of suitable variations and modifications to the above purely exemplary descriptions, which variations and modifications are within the scope of present invention as determined solely by the appended claims.

I claim:

1. A decorative rigid body supply arrangement comprising:
a supply strip having a direction of elongation, left and right sides and upper and lower sides, wherein the supply strip includes a plurality of through holes extending from the upper side to the lower side and spaced apart in the direction of elongation;
a plurality of decorative rigid bodies received in the through holes, wherein each through hole has an inner periphery which is in contact with an upper portion of an outer periphery of the decorative rigid body received in the through hole; and
one or more elastic tapes adhered to the lower side of the supply strip, wherein the one or more elastic tapes provide at least one aperture, wherein the at least one aperture is registered with at least one of the through holes, wherein a periphery of the one or more elastic tapes holds the decorative rigid body within the through hole.

2. The arrangement according to claim 1, wherein the periphery of the one or more elastic tapes is in contact with a lower portion of an outer periphery of the decorative rigid body received in the through hole.

3. The arrangement according to claim 2, wherein the supply strip has a smallest thickness in a region between adjacent through holes, and wherein a location where the elastic tape contacts the lower portion of the outer periphery of the decorative rigid body is spaced apart from another location where the inner periphery of the through hole contacts the upper portion of the outer periphery of the decorative rigid body by a distance in a direction orthogonal to the upper side, and wherein the distance is greater than the smallest thickness.

4. The arrangement according to claim 2, wherein the lower portion of the outer periphery of the decorative rigid body has a surface normal at a location where the one or more elastic tapes contact the lower portion of the outer periphery of the decorative rigid body, and wherein an angle between the surface normal and a plane of extension of the lower side of the supply strip is smaller than one of 75°, 65° and 50°.

5. The arrangement according to claim 3, wherein the lower portion of the outer periphery of the decorative rigid body has a surface normal at a location where the one or more elastic tapes contact the lower portion of the outer periphery of the decorative rigid body, and wherein an angle between the surface normal and a plane of extension of the lower side of the supply strip is smaller than one of 75°, 65° and 50°.

6. The arrangement according to claim 1, wherein the periphery of the one or more elastic tapes is in contact with a lower face of the decorative rigid body.

7. The arrangement according to claim 1, wherein the decorative rigid bodies each have a first flat face projecting from the upper side of the supply strip.

8. The arrangement according to claim 7, wherein the projection amount is 0.01 to 0.1 mm.

9. The arrangement according to claim 1, wherein the one or more elastic tapes comprise first and second separate elastic tapes adhered to the lower side of the supply strip, wherein the first and second elastic tapes are spaced apart from each other in order to define the at least one aperture, wherein the at least one aperture is a contiguous gap extending across plural adjacent, or all through holes.

10. The arrangement according to claim 1, wherein portions of the through holes providing the inner peripheries have slits extending towards the lower side farther than the thickness of the material.

11. The arrangement according to claim 1, wherein the supply strip includes a plurality of projections and indentations provided on at least one of its left side and its right side, wherein mutually adjacent projections and indentations optionally provide a straight edge portion, which straight edge portion further optionally is substantially perpendicular to the direction of elongation.

12. A method of manufacturing the arrangement according to claim 1, the method comprising:
making bottomed pouches in a flat strip material;
punching holes in the pouch bottoms so as to provide the through holes;
optionally cutting slits, e.g. one or two pairs of slits, in the pouch rims from their bottom sides, further optionally orienting the slits in the direction of elongation;
placing the decorative rigid bodies in the pouches, optionally leaving leading pouches empty;
adhering the one or more elastic tapes onto the side of the strip material away from the bottoms, optionally by welding; and
optionally providing the plurality of projections and indentations on the left and/or right side of the supply strip.

13. Use of the decorative rigid body supply arrangement according to claim 1, for applying the decorative rigid bodies to a substrate, comprising:
supplying the decorative rigid bodies such that at least one decorative rigid body of the plurality of rigid bodies is arranged close to a first substrate; and
pushing the at least one decorative rigid body out of the through hole, such that the decorative rigid body contacts the first substrate.

14. The use according to claim 13, comprising providing the decorative rigid bodies with a first adhesive such that they adhere to the first substrate when in contact.

15. The use according to claim 13, comprising providing the first substrate with a first adhesive such that the decorative rigid bodies adhere to the first substrate.

16. The use according to claim 14, further comprising:
bringing plural decorative rigid bodies adhered to the first substrate in contact with a second substrate; activating a second adhesive provided between the rigid bodies and the second substrate; and
separating the first substrate from the plural decorative rigid bodies adhering to the second substrate.

17. The use according to claim 15, further comprising:
bringing plural decorative rigid bodies adhered to the first substrate in contact with a second substrate; activating a second adhesive provided between the rigid bodies and the second substrate; and
separating the first substrate from the plural decorative rigid bodies adhering to the second substrate.

18. The use according to claim 16, wherein the first adhesive is activated by applying a force between the decorative rigid body and the first substrate and wherein the second adhesive is activated by applying heat to the second adhesive.

19. The use according to claim 17, wherein the first adhesive is activated by applying a force between the decorative rigid body and the first substrate and wherein the second adhesive is activated by applying heat to the second adhesive.
